(19) United States
(12) Patent Application Publication
(10) Pub. No.: US 2021/0043937 A1
(43) Pub. Date: Feb. 11, 2021

(54) BATTERY, BATTERY PACK, ELECTRONIC DEVICE, ELECTRICALLY DRIVEN VEHICLE, AND POWER STORAGE SYSTEM

(71) Applicant: MURATA MANUFACTURING CO., LTD., Kyoto (JP)

(72) Inventor: Takuju HASHIMOTO, Kyoto (JP)

(21) Appl. No.: 17/078,986

(22) Filed: Oct. 23, 2020

Related U.S. Application Data
(63) Continuation of application No. PCT/JP2019/017999, filed on Apr. 26, 2019.

(30) Foreign Application Priority Data
Apr. 27, 2018 (JP) 2018-087813

(51) Int. Cl. H01M 4/62; H01M 10/0569

(52) U.S. Cl. CPC H01M 4/623; H01M 2004/021; H01M 10/0569

(57) ABSTRACT

A battery includes a positive electrode, a negative electrode, and an electrolytic solution. The positive electrode includes a positive electrode active material layer including a fluorine-based binder having a melting point of 166° C. or less. The content of the fluorine-based binder in the positive electrode active material layer is from 0.7% by mass to 2.8% by mass. The electrolytic solution includes a carboxylic acid ester, and the carboxylic acid ester has 4 or more and 10 or less carbon atoms.

### CROSS REFERENCE TO RELATED APPLICATIONS

The present application is a continuation of PCT patent application no. PCT/JP2019/017999, filed on Apr. 26, 2019, which claims priority to Japanese patent application no. JP2018-087813 filed on Apr. 27, 2018, the entire contents of which are being incorporated herein by reference.

### BACKGROUND

The present technology generally relates to a battery, a battery pack, an electronic device, an electrically driven vehicle, and a power storage system.

In recent years, a technology to use binders with low melting points as binders for electrodes has been investigated in order to improve battery characteristics.

### SUMMARY

The present technology generally relates to a battery, a battery pack, an electronic device, an electrically driven vehicle, and a power storage system.

However, in batteries in which conventional binders having low melting points are used, the load characteristics are not sufficient and improvement in the load characteristics is thus desired.

An object of the present invention is to provide a battery, a battery pack, an electronic device, an electrically driven vehicle, and a power storage system which can exhibit favorable load characteristics.

In order to solve the above problems, a battery is provided according to an embodiment of the present disclosure. The battery includes a positive electrode, a negative electrode, and an electrolytic solution, the positive electrode includes a positive electrode active material layer including a fluorine-based binder having a melting point of 166° C. or less, the content of the fluorine-based binder in the positive electrode active material layer is from 0.7% by mass to 2.8% by mass, and the electrolytic solution includes a carboxylic acid ester, and the carboxylic acid ester has 4 or more and 10 or less carbon atoms.

According to an embodiment of the present disclosure, a battery pack is provided. The battery pack includes the battery according to an embodiment as described herein and a controller configured to control the battery.

According to an embodiment of the present disclosure, an electronic device is provided. The electronic device includes the battery according to an embodiment as described herein and the electronic device is configured to receive power supply from the battery.

According to an embodiment of the present disclosure, an electrically driven vehicle is provided. The electrically driven vehicle includes the battery according to an embodiment as described herein and a converter configured to receive power supply from the battery and convert the power into driving force for the vehicle.

According to an embodiment of the present disclosure, a power storage system is provided. The power storage system includes the battery according to an embodiment as described herein.

According to the present invention, favorable load characteristics can be attained. It should be understood that the effects described here are not necessarily limited and may be any one of the effects described in the present invention or an effect different from them.

### BRIEF DESCRIPTION OF THE FIGURES

FIG. 1 is a sectional view illustrating an example of the configuration of a non-aqueous electrolyte secondary battery according to an embodiment of the present disclosure.

FIG. 2 is an enlarged sectional view illustrating a part of the wound type electrode body illustrated in FIG. 1.

FIG. 3 is an exploded perspective view illustrating an example of the configuration of a non-aqueous electrolyte secondary battery according to an embodiment of the present disclosure.

FIG. 4 is a sectional view taken along the line IV-IV in FIG. 3.

FIG. 5 is a block diagram illustrating an example of the configuration of an electronic device as an application example according to an embodiment of the present disclosure.

FIG. 6 is a schematic diagram illustrating an example of the configuration of a vehicle as an application example according to an embodiment of the present disclosure.

### DETAILED DESCRIPTION

As described herein, the present disclosure will be described based on examples with reference to the drawings, but the present disclosure is not to be considered limited to the examples, and various numerical values and materials in the examples are considered by way of example.

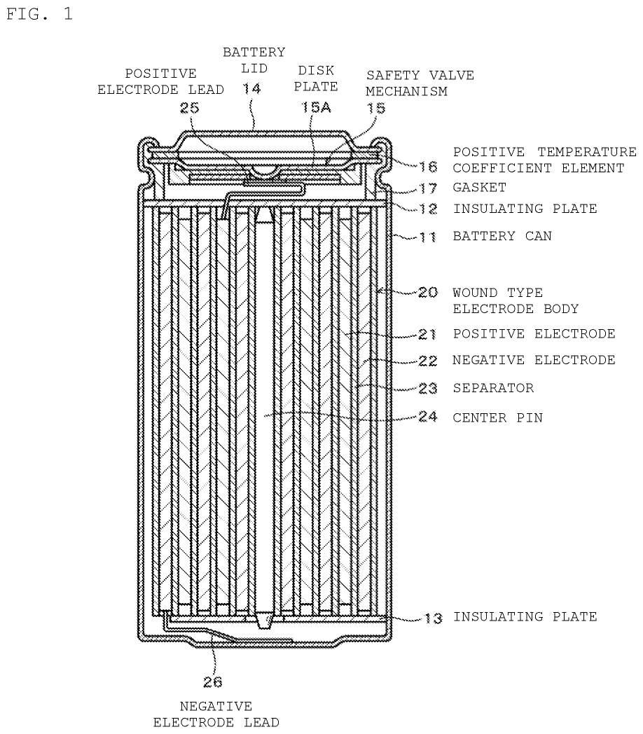

Hereinafter, an example of the configuration of a non-aqueous electrolyte secondary battery (hereinafter, simply referred to as “battery”) according to a first embodiment of the present invention will be described with reference to FIG. 1. This battery is, for example, a cylindrical type lithium ion secondary battery. This battery includes a wound type electrode body 20 in which a pair of strip-like positive electrode 21 and strip-like negative electrode 22 are stacked with a separator 23 interposed therebetween and then wound inside a substantially hollow columnar battery can 11. The battery can 11 is formed of nickel-plated iron and has one end portion closed and the other end portion open. An electrolytic solution as a liquid electrolyte is injected into the battery can 11, and the positive electrode 21, the negative electrode 22, and the separator 23 are impregnated with the electrolytic solution. A pair of insulating plates 12 and 13 is disposed perpendicularly to the wound peripheral surface so as to sandwich the wound type electrode body 20 therebetween.

A battery lid 14 and a safety valve mechanism 15 and a positive temperature coefficient element (PTC element) 16 which are provided inside this battery lid 14 are attached to the open end portion of the battery can 11 by being crimped with a sealing gasket 17 interposed therebetween. The inside of the battery can 11 is thus hermitically sealed. The battery lid 14 is formed of, for example, a material similar to that of the battery can 11. The safety valve mechanism 15 is electrically connected to the battery lid 14 and is configured so that a disk plate 15A is inverted to disconnect the electrical connection between the battery lid 14 and the wound type electrode body 20 when the internal pressure of the battery is equal to or higher than a certain level by an internal short circuit, heating from the outside, or the like. The sealing gasket 17 is formed of, for example, an insulating material, and its surface is coated with asphalt.

For example, a center pin 24 is inserted in the center of the wound type electrode body 20. A positive electrode lead 25 formed of aluminum or the like is connected to the positive electrode 21 of the wound type electrode body 20, and a negative electrode lead 26 formed of nickel or the like is connected to the negative electrode 22. The positive electrode lead 25 is electrically connected to the battery lid 14 by being welded to the safety valve mechanism 15, and the negative electrode lead 26 is welded and electrically connected to the battery can 11.

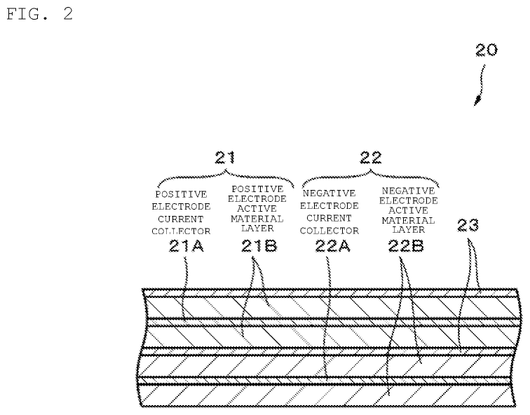

Hereinafter, the positive electrode 21, negative electrode 22, separator 23, and electrolytic solution which constitute the battery will be sequentially described with reference to FIG. 2.

The positive electrode 21 has, for example, a structure in which a positive electrode active material layer 21B is provided on both surfaces of a positive electrode current collector 21A. The positive electrode current collector 21A is formed of, for example, a metal foil such as an aluminum foil, a nickel foil, or a stainless foil. The positive electrode active material layer 21B contains a positive electrode active material and a binder. The positive electrode active material layer 21B may further contain a conductive agent, if necessary.

As the positive electrode active material capable of storing and releasing lithium, a lithium-containing compound, for example, lithium oxide, lithium phosphorus oxide, lithium sulfide, or an intercalation compound containing lithium is suitable, and two or more of these may be used in mixture. In order to increase the energy density, a lithium-containing compound which contains lithium, a transition metal element, and oxygen (O) is preferable. Examples of such a lithium-containing compound include a lithium composite oxide having a layered rock salt type structure represented by Formula (A) and a lithium composite phosphate having an olivine type structure represented by Formula (B). The lithium-containing compound is more preferably one containing at least one selected from the group consisting of cobalt (Co), nickel (Ni), manganese (Mn), and iron (Fe) as a transition metal element. Examples of such a lithium-containing compound include a lithium composite oxide having a layered rock salt type structure represented by Formula (C), Formula (D), or Formula (E), a lithium composite oxide having a spinel type structure represented by Formula (F), or a lithium composite phosphate having an olivine type structure represented by Formula (G). Specific examples thereof include Li₁Ni_{0.50}Co_{0.20}Mn_{0.30}O₂, Li₁CoO₂, Li₁NiO₂, Li₁NiₐCo₁₋ₐO₂ (0<a<1), Li₁Mn₂O₄, or Li₁FePO₄.

LiₚNi_{(1-q-r)}Mn_{q}M1ᵣO_{(2-y)}X_{z} (A)

(In Formula (A), M1 represents at least one selected from the elements belonging to the groups 2 to 15 except nickel and manganese. X represents at least one among the elements belonging to the group 16 and the elements belonging to the group 17 other than oxygen. p, q, y, and z are values within ranges of 0≤p≤1.5, 0≤q≤1.0, 0≤r≤1.0, −0.10≤y≤0.20, and 0≤z≤0.2.)

LiₐM2_{b}PO₄ (B)

(In Formula (B), M2 represents at least one selected from the elements belonging to the groups 2 to 15. a and b are values within ranges of 0≤a≤2.0 and 0.5≤b≤2.0.)

Li_{f}Mn_{(1-g-h)}Ni_{g}M3ₕO₍₂₋ⱼ₎Fₖ (C)

(In Formula (C), M3 represents at least one selected from the group consisting of cobalt, magnesium (Mg), aluminum, boron (B), titanium (Ti), vanadium (V), chromium (Cr), iron, copper, zinc (Zn), zirconium (Zr), molybdenum (Mo), tin (Sn), calcium (Ca), strontium (Sr), and tungsten (W). f, g, h, j, and k are values within ranges of 0.8≤f≤1.2, 0≤g≤0.5, 0≤h≤0.5, g+h≤1, −0.1≤j≤0.2, and 0≤k≤0.1. The composition of lithium differs depending on the state of charge and discharge, and the value off represents a value in the fully discharged state.)

LiₘNi₍₁₋ₙ₎M4ₙO₍₂₋ₚ₎F_{q} (D)

(In Formula (D), M4 represents at least one selected from the group consisting of cobalt, manganese, magnesium, aluminum, boron, titanium, vanadium, chromium, iron, copper, zinc, molybdenum, tin, calcium, strontium, and tungsten. m, n, p, and q are values within ranges of 0.8≤m≤1.2, 0.005≤n≤0.5, −0.1≤p≤0.2, and 0≤q≤0.1. The composition of lithium differs depending on the state of charge and discharge, and the value of m represents a value in the fully discharged state.)

LiᵣCo₍₁₋ₛ₎M5ₛO₍₂₋ₜ₎Fᵤ (E)

(In Formula (E), M5 represents at least one selected from the group consisting of nickel, manganese, magnesium, aluminum, boron, titanium, vanadium, chromium, iron, copper, zinc, molybdenum, tin, calcium, strontium, and tungsten. r, s, t, and u are values within ranges of 0.8≤r≤1.2, 0≤s≤0.5, −0.1≤t≤0.2, and 0≤u≤0.1. The composition of lithium differs depending on the state of charge and discharge, and the value of r represents a value in the fully discharged state.)

LiᵥMn_{2-w}M6_{w}OₓF_{y} (F)

(In Formula (F), M6 represents at least one selected from the group consisting of cobalt, nickel, magnesium, aluminum, boron, titanium, vanadium, chromium, iron, copper, zinc, molybdenum, tin, calcium, strontium, and tungsten. v, w, x, and y are values within ranges of 0.9≤v≤1.1, 0≤w≤0.6, 3.7≤x≤4.1, and 0≤y≤0.1. The composition of lithium differs depending on the state of charge and discharge, and the value of v represents a value in the fully discharged state.)

Li_{z}M7PO₄ (G)

(In Formula (G), M7 represents at least one selected from the group consisting of cobalt, manganese, iron, nickel, magnesium, aluminum, boron, titanium, vanadium, niobium (Nb), copper, zinc, molybdenum, calcium, strontium, tungsten, and zirconium. z is a value within a range of 0.9≤z≤1.1. The composition of lithium differs depending on the state of charge and discharge, and the value of z represents a value in the fully discharged state.)

Examples of the positive electrode active material capable of storing and releasing lithium also include inorganic compounds which do not contain lithium such as MnO₂, V₂O₅, V₆O₁₃, NiS, and MoS in addition to these.

The positive electrode active material capable of storing and releasing lithium may be one other than the above. Two or more of the positive electrode active materials exemplified above may be mixed in any combination.

The binder for the positive electrode contains a fluorine-based binder having a melting point of 166° C. or less. When the melting point of the fluorine-based binder is 166° C. or less, the binder is easily melted when the positive electrode active material layer 21B is subjected to a heat treatment in the battery manufacturing process and the surface of the positive electrode active material grains can be coated with a highly uniform binder layer. Hence, the reaction between the positive electrode active material grains and the electrolytic solution can be effectively suppressed. The thermal stability of the positive electrode 21 can also be improved, and thus the safety of the battery can be improved. Furthermore, the surface of the positive electrode active material grains can be protected with a small amount of binder, thus the content of the positive electrode active material in the positive electrode active material layer 21B can be increased and the battery capacitance can be increased. The lower limit value of the melting point of the fluorine-based binder is not particularly limited but is, for example, 150° C. or more.

The melting point of the fluorine-based binder is measured as follows. First, the positive electrode 21 is taken out from the battery 10, washed with dimethyl carbonate (DMC), and dried, then the positive electrode current collector 21A is removed therefrom, and the rest is heated and stirred in a suitable dispersion medium (for example, N-methylpyrrolidone) to dissolve the binder in the dispersion medium. Thereafter, the positive electrode active material is removed from the solution by centrifugation, the supernatant liquid is filtered, and then the residue is subjected to evaporation to dryness or reprecipitation in water, whereby the binder can be taken out.

Next, a sample in an amount of several to several tens of mg is heated at a rate of temperature rise of 1° C./min to 10° C./min using DSC (differential scanning calorimeter, for example, Rigaku Thermoplus DSC8230 manufactured by Rigaku Corporation), and the temperature at which the maximum endothermic energy amount is attained is taken as the melting point of the fluorine-based binder among the endothermic peaks that appear in the temperature range from 100° C. to 250° C. In the present invention, the temperature at which the polymer becomes fluid by heating and temperature rise is defined as the melting point.

The fluorine-based binder is, for example, polyvinylidene fluoride (PVdF). As polyvinylidene fluoride, it is preferable to use a homopolymer containing vinylidene fluoride (VdF) as a monomer. As the polyvinylidene fluoride, it is also possible to use a copolymer containing vinylidene fluoride (VdF) as a monomer. As the polyvinylidene fluoride, one obtained by modifying a part of its end and the like with a carboxylic acid such as maleic acid may be used.

The content of the fluorine-based binder in the positive electrode active material layer 21B is 0.7% by mass or more and 2.8% by mass or less, preferably 1.0% by mass or more and 2.2% by mass or less, more preferably 1.4% by mass or more and 1.8% by mass or less. When the content of the fluorine-based binder is less than 0.7% by mass, it is impossible to sufficiently maintain the binding property between the positive electrode active material grains, independent positive electrode active material grains are generated, and thus the load characteristics may be deteriorated. On the other hand, when the content of the fluorine-based binder exceeds 2.8% by mass, the amount of the bander covering the positive electrode active material grains is too large, the resistance of ionic conduction increases, and thus the load characteristics may be deteriorated.

The content of the fluorine-based binder is measured as follows. First, the positive electrode 21 is taken out from the battery 10, washed with DMC, and dried. Next, a sample in an amount of several to several tens of mg is heated to 600° C. at a rate of temperature rise of 1° C./min to 5° C./min in an air atmosphere using a thermogravimetric-differential thermal analyzer (TG-DTA, for example, Rigaku Thermo plus TG8120 manufactured by Rigaku Corporation), and the content of the fluorine-based binder in the positive electrode active material layer 21B is determined from the amount of weight reduction at that time. Whether or not the amount of weight reduction due to the binder can be confirmed by isolating the binder, performing TG-DTA measurement of only the binder in an air atmosphere, and examining at what temperature the binder burns as described in the method for measuring the melting point of the binder.

Examples of the conductive agent include carbon materials such as graphite, carbon fibers, carbon black, Ketjen black, or carbon nanotubes. One of these may be used singly or two or more thereof may be used in mixture. The conductive agent may be any material exhibiting conductivity and is not limited to the carbon materials. For example, a metal material or a conductive polymer material may be used as the conductive agent.

The volume density of the positive electrode active material layer 21B is preferably 3.8 g/cm³ or more, more preferably 4.0 g/cm³ or more, more preferably 4.2 g/cm³ or more. When the volume density of the positive electrode active material layer 21B is 3.8 g/cm³ or more, the effect of improving the load characteristics attained by the battery according to the first embodiment is particularly remarkably exerted. The upper limit value of the volume density of the positive electrode active material layer 21B is not particularly limited but is, for example, 5 g/cm³ or less.

The volume density of the positive electrode active material layer 21B is determined as follows. First, the battery in a state of being discharged to a final voltage of 3.0 V is disassembled, the positive electrode 21 is taken out therefrom and dried. Next, the positive electrode 21 is punched into a circular shape to obtain a positive electrode piece. Next, the mass of the positive electrode piece is measured using an electronic balance, and the thickness of the positive electrode piece is measured using a height meter. Next, the positive electrode active material layer 21B of the positive electrode piece is removed by being dissolved in a solvent such as N-methyl-2-pyrrolidone (NMP) or dimethyl carbonate (DMC) to obtain a positive electrode current collector piece, and the mass and thickness of this positive electrode current collector piece are measured. Next, the volume density of the positive electrode active material layer 21B is determined using the following equation.

Volume density [g/cm³]=(mass of positive electrode piece [g]−mass of positive electrode current collector piece [g])/(area of positive electrode piece [cm²]×(thickness of positive electrode piece [cm]−thickness of positive electrode current collector piece [cm]))

However, the area [cm²] of the positive electrode piece is the area of the circular main surface of the positive electrode piece.

The negative electrode 22 has, for example, a structure in which a negative electrode active material layer 22B is provided on both surfaces of a negative electrode current collector 22A. The negative electrode current collector 22A is formed of, for example, a metal foil such as a copper foil, a nickel foil, or a stainless foil.

The negative electrode active material layer 22B contains one or two or more negative electrode active materials capable of storing and releasing lithium. The negative electrode active material layer 22B may further contain at least one of a binder or a conductive agent, if necessary.

In this battery, it is preferable that the electrochemical equivalent of the negative electrode 22 or negative electrode active material is greater than the electrochemical equivalent of the positive electrode 21 and lithium metal is not deposited on the negative electrode 22 during charge in theory.

Examples of the negative electrode active material include carbon materials such as non-graphitizable carbon, graphitizable carbon, graphite, pyrolytic carbons, cokes, glassy carbons, organic polymer compound fired bodies, carbon fibers, or activated carbon. Among these, the cokes include pitch coke, needle coke, petroleum coke or the like. The term “organic polymer compound fired bodies” refers to one obtained by firing a polymer material such as phenol resin or furan resin at an appropriate temperature for carbonization, and some organic polymer compound fired bodies are classified as non-graphitizable carbon or graphitizable carbon. These carbon materials are preferable since the change in crystal structure that occurs at the time of charge and discharge is significantly small, a high charge and discharge capacitance can be attained, and favorable cycle characteristics can be attained. Particularly, graphite is preferable since graphite has a great electrochemical equivalent and a high energy density can be attained. Non-graphitizable carbon is preferable since excellent cycle characteristics can be attained. Furthermore, those having a low charge and discharge potential, specifically those having a charge and discharge potential close to that of lithium metal are preferable since it is possible to easily realize a high energy density of the battery.

Other negative electrode active materials capable of increasing the capacitance also include materials containing at least one of a metal element or a metalloid element as a constituent element (for example, an alloy, a compound, or a mixture). This is because a high energy density can be attained when such a material is used. In particular, it is more preferable to use these materials together with the carbon materials since it is possible to attain a high energy density and excellent cycle characteristics. In the present invention, the alloy also includes alloys containing one or more metal elements and one or more metalloid elements in addition to alloys composed of two or more metal elements. The alloy may contain a nonmetallic element. The texture thereof includes a solid solution, a eutectic (eutectic mixture), an intermetallic compound, or coexistence of two or more thereof.

Examples of such a negative electrode active material include a metal element or metalloid element capable of forming an alloy with lithium. Specific examples thereof include magnesium, boron, aluminum, titanium, gallium (Ga), indium (In), silicon (Si), germanium (Ge), tin (Sn), lead (Pb), bismuth (Bi), cadmium (Cd), silver (Ag), zinc, hafnium (Hf), zirconium (Zr), yttrium (Y), palladium (Pd), or platinum (Pt). These may be crystalline or amorphous.

The negative electrode active material preferably contains a metal element or metalloid element of the group 4B in the short periodic table as a constituent element and more preferably contains at least either of silicon or tin as a constituent element. This is because silicon and tin have a great ability to store and release lithium and a high energy density can be attained. Examples of such a negative electrode active material include a simple substance, an alloy, or a compound of silicon, and a simple substance, an alloy, or a compound of tin, and materials having one or two or more of these at least at a part.

Examples of the alloy of silicon include those containing at least one selected from the group consisting of tin, nickel, copper, iron, cobalt, manganese, zinc, indium, silver, titanium, germanium, bismuth, antimony (Sb), niobium, molybdenum, aluminum, phosphorus (P), gallium, and chromium as the second constituent element other than silicon. Examples of the alloy of tin include those containing at least one selected from the group consisting of silicon, nickel, copper, iron, cobalt, manganese, zinc, indium, silver, titanium, germanium, bismuth, antimony, niobium, molybdenum, aluminum, phosphorus, gallium, and chromium as the second constituent element other than tin. This is because the capacitance or cycle characteristics can be further improved.

Examples of the compound of tin or the compound of silicon include those containing oxygen or carbon. These compounds may contain the above-mentioned second constituent elements.

Among these, the Sn-based negative electrode active material preferably contains cobalt, tin, and carbon as constituent elements and has a low crystalline or amorphous structure.

Examples of other negative electrode active materials also include metal oxides or polymer compounds capable of storing and releasing lithium. Examples of the metal oxides include lithium-titanium oxide containing titanium and lithium such as lithium titanate (Li₄Ti₅O₁₂), iron oxide, ruthenium oxide, or molybdenum oxide. Examples of the polymer compounds include polyacetylene, polyaniline, or polypyrrole.

As the binder for the negative electrode, for example, at least one selected from resin materials such as polyvinylidene fluoride, polytetrafluoroethylene, polyacrylonitrile, styrene-butadiene rubber, and carboxymethyl cellulose or copolymers containing these resin materials as main components is used.

As the conductive agent, conductive agents similar to those for the positive electrode active material layer 21B can be used.

The separator 23 separates the positive electrode 21 and the negative electrode 22 from each other, prevents short circuit of current due to the contact between both electrodes, and allows lithium ions to pass through. The separator 23 is formed of, for example, a porous film formed of polytetrafluoroethylene, a polyolefin resin (polypropylene (PP), polyethylene (PE) or the like), an acrylic resin, a styrene resin, a polyester resin, a nylon resin, or a resin obtained by blending these resins and may have a structure in which two or more of these porous films are laminated.

Among these, a polyolefin porous film is preferable since this has an excellent short circuit preventing effect and the safety of the battery can be improved by the shutdown effect. Particularly, polyethylene is preferable as a material forming the separator 23 since polyethylene is also excellent in electrochemical stability and a shutdown effect can be attained in a range of 100° C. or more and 160° C. or less. Among these, low-density polyethylene, high-density polyethylene, and linear polyethylene have suitable melting temperatures and are easily procured, and thus are suitably used. In addition, a material obtained by copolymerizing or blending a resin exhibiting chemical stability with polyethylene or polypropylene can be used. Alternatively, the porous film may have a structure composed of three or more layers in which a polypropylene layer, a polyethylene layer, and a polypropylene layer are sequentially laminated. For example, it is desirable to have a three-layer structure of PP/PE/PP and a mass ratio [wt %] of PP to PE in PP:PE=60:40 to 75:25. Alternatively, a single-layer substrate formed of 100 wt % PP or 100 wt % PE can be used from the viewpoint of cost. The method for fabricating the separator may be either of a wet method or a dry method.

A nonwoven fabric may be used as the separator 23. As the fibers constituting the nonwoven fabric, aramid fibers, glass fibers, polyolefin fibers, polyethylene terephthalate (PET) fibers, nylon fibers or the like can be used. A nonwoven fabric may be formed by mixing two or more of these fibers.

The separator 23 may have a configuration including a substrate and a surface layer provided on one surface or both surfaces of the substrate. The surface layer contains inorganic grains exhibiting electrical insulation property and a resin material which binds the inorganic grains to the surface of the substrate and the inorganic grains to each other. This resin material may be, for example, fibrillated and have a three-dimensional network structure in which a plurality of fibrils are linked to each other. The inorganic grains are supported on the resin material having this three-dimensional network structure. The resin material may bind the surface of the substrate and the inorganic grains without being fibrillated. In this case, higher binding property can be attained. By providing the surface layer on one surface or both surfaces of the substrate as described above, the oxidation resistance, heat resistance, and mechanical strength of the separator 23 can be enhanced.

The substrate is a porous film which is permeable to lithium ions and is formed of an insulating film having a predetermined mechanical strength, and it is preferable that the substrate has characteristics to exhibit high resistance to the electrolytic solution, exhibit low reactivity, and hardly expand since the electrolytic solution is retained in the holes of the substrate.

As the material forming the substrate, the resin material or nonwoven fabric forming the above-described separator can be used.

The inorganic grains contain at least one of a metal oxide, a metal nitride, a metal carbide, a metal sulfide or the like. As the metal oxide, it is possible to suitably use aluminum oxide (alumina, Al₂O₃), boehmite (hydrated aluminum oxide), magnesium oxide (magnesia, MgO), titanium oxide (titania, TiO₂), zirconium oxide (zirconia, ZrO₂), silicon oxide (silica, SiO₂), yttrium oxide (yttria, Y₂O₃) or the like. As the metal nitride, it is possible to suitably use silicon nitride (Si₃N₄), aluminum nitride (AlN), boron nitride (BN), titanium nitride (TiN) or the like. As the metal carbide, it is possible to suitably use silicon carbide (SiC), boron carbide (B₄C) or the like. As the metal sulfide, it is possible to suitably use barium sulfate (BaSO₄) or the like. Minerals such as porous aluminosilicate such as zeolite (M_{2/n}O·Al₂O₃.xSiO₂·yH₂O, M is a metal element, x≥2, y≥0), layered silicate, barium titanate (BaTiO₃), or strontium titanate (SrTiO₃) may be used. Among these, it is preferable to use alumina, titania (particularly those having a rutile type structure), silica, or magnesia and it is more preferable to use alumina. The inorganic grains exhibit oxidation resistance and heat resistance, and the surface layer of the positive electrode-facing side surface containing the inorganic grains exhibits strong resistance to the oxidizing environment in the vicinity of the positive electrode at the time of charge. The shape of the inorganic grains is not particularly limited, and any of spherical, plate-like, fibrous, cubic, or random-shaped inorganic grains can be used.

The grain size of the inorganic grains is preferably in a range of 1 nm to 10 μm. This is because it is difficult to procure the inorganic grains when the grain size is smaller than 1 nm and the distance between the electrodes is electrodes is far, the amount of active material filled in the limited spaces not sufficiently attained, and the battery capacitance is low when the grain size is larger than 10 μm.

Examples of the resin material forming the surface layer include resins exhibiting high heat resistance as at least either of the melting point or the glass transition temperature thereof is 180° C. or more such as fluorine-containing resins such as polyvinylidene fluoride and polytetrafluoroethylene, fluorine-containing rubber such as vinylidene fluoride-tetrafluoroethylene copolymer and ethylene-tetrafluoroethylene copolymer, rubbers such as styrene-butadiene copolymer or hydrides thereof, acrylonitrile-butadiene copolymer or hydrides thereof, acrylonitrile-butadiene-styrene copolymer or hydrides thereof, methacrylic acid ester-acrylic acid ester copolymer, styrene-acrylic acid ester copolymer, acrylonitrile-acrylic acid ester copolymer, ethylene propylene rubber, polyvinyl alcohol, and polyvinyl acetate, cellulose derivatives such as ethyl cellulose, methyl cellulose, hydroxyethyl cellulose, and carboxymethyl cellulose, polyphenylene ether, polysulfone, polyether sulfone, polyphenylene sulfide, polyetherimide, polyimide, polyamide such as wholly aromatic polyamide (aramid), polyamide-imide, polyacrylonitrile, polyvinyl alcohol, polyether, an acrylic acid resin, or polyester. These resin materials may be used singly or in mixture of two or more thereof. Among these, a fluorine-based resin such as polyvinylidene fluoride is preferable from the viewpoint of oxidation resistance and flexibility and it is preferable to contain aramid or polyamide-imide from the viewpoint of heat resistance.

As the method for forming the surface layer, it is possible to use, for example, a method in which a slurry containing a matrix resin, a solvent, and an inorganic material is applied onto a substrate (porous film) and the applied slurry is allowed to pass through a poor solvent of the matrix resin and a bath of a good solvent of the solvent for phase separation and then dried.

The above-described inorganic grains may be contained in the porous film as a substrate. The surface layer may not contain inorganic grains but may be formed only of a resin material.

The electrolytic solution contains a solvent and an electrolyte salt dissolved in this solvent. The electrolytic solution may further contain a known additive in order to improve battery characteristics.

The solvent includes a carbonic acid ester (carbonate-based solvent) and a carboxylic acid ester. As the solvent contains a carboxylic acid ester, the electrolytic solution can be infiltrated into the positive electrode active material layer 21B while suppressing swelling of the binder due to a carbonic acid ester and maintaining the conductive network of the positive electrode active material. Hence, the load characteristics can be improved.

The carbonic acid ester may be a cyclic carbonic acid ester, a chain carbonic acid ester, or a mixture of these. The carbonic acid ester includes, for example, at least one of ethylene carbonate (EC), propylene carbonate (PC), butylene carbonate (BC), dimethyl carbonate (DMC), diethyl carbonate (DEC), or ethyl methyl carbonate (EMC).

The carboxylic acid ester has 4 or more and 10 or less, preferably 4 or more and 8 or less, more preferably 4 or more and 6 or less carbon atoms. When the carboxylic acid ester has 3 or less carbon atoms, the reactivity is high, thus the by-products during charge and discharge increase the electrode surface resistance, and the load characteristics are deteriorated. The reason why the reactivity is high when the number of carbon atoms is 3 or less is considered to be because the aldehyde group of the formic acid ester exhibits reducing property. On the other hand, when the carboxylic acid ester has more than 10 carbon atoms, the viscosity of the electrolytic solution greatly increases due to an increase in the molecular weight, thus the transfer resistance of lithium ions increases, and the load characteristics are deteriorated.

As the carboxylic acid ester having 4 or more and 10 or less carbon atoms, it is possible to use, for example, at least one of ethyl acetate (carbon number: 4), ethyl propionate (carbon number: 5), ethyl butyrate (carbon number: 5), propyl propionate (carbon number: 6), ethyl isobutyrate (carbon number: 6), ethyl pivalate (carbon number: 6), isopropyl propionate (carbon number: 6), tert-butyl propionate (carbon number: 7), butyl butyrate (carbon number: 8), ethyl caproate (carbon number: 8), hexyl butyrate (carbon number: 10), or ethyl octoate (carbon number: 10).

The content of the carboxylic acid ester in the electrolytic solution solvent is preferably 40% by volume or more and 80% by volume or less. When the content of the carboxylic acid ester is in the above range, particularly favorable load characteristics can be attained.

Examples of the electrolyte salt include a lithium salt, and one may be used singly or two or more may be used in mixture. Examples of the lithium salt include LiPF₆, LiBF₄, LiAsF₆, LiClO₄, LiB(C₆H₅)₄, LiCH₃SO₃, LiCF₃SO₃, LiN(SO₂CF₃)₂, LiC(SO₂CF₃)₃, LiAlCl₄, LiSiF₆, LiCl, lithium difluoro[oxolato-O,O′]borate, lithium bisoxalate borate, or LiBr. Among these, LiPF₆ is preferable since high ionic conductivity can be attained and cycle characteristics can be improved.

In the battery according to the first embodiment, the open circuit voltage (namely, battery voltage) in the fully charged state per pair of the positive electrode 21 and the negative electrode 22 may be less than 4.25 V but may be designed so as to be preferably 4.25 V or more, more preferably 4.3 V or more, still more preferably 4.4 V or more. A high energy density can be attained by increasing the battery voltage. The upper limit value of the open circuit voltage in the fully charged state per pair of the positive electrode 21 and the negative electrode 22 is preferably 6 V or less, more preferably 4.6 V or less, still more preferably 4.5 V or less.

In the battery having the above-described configuration, when charge is performed, for example, lithium ions are released from the positive electrode active material layer 21B and stored in the negative electrode active material layer 22B via the electrolytic solution. When discharge is performed, for example, lithium ions are released from the negative electrode active material layer 22B and stored in the positive electrode active material layer 21B via the electrolytic solution.

Next, an example of the method for manufacturing the battery according to the first embodiment of the present invention will be described.

The positive electrode 21 is fabricated as follows. First, for example, a positive electrode active material, a conductive agent, and a binder are mixed together to prepare a positive electrode mixture, and this positive electrode mixture is dispersed in a solvent such as N-methyl-2-pyrrolidone (NMP) to prepare a paste-like positive electrode mixture slurry. Next, this positive electrode mixture slurry is applied to the positive electrode current collector 21A, the solvent is dried, compression molding is performed using a roll pressing machine or the like to form the positive electrode active material layer 21B, and the positive electrode 21 is thus obtained.

The negative electrode 22 is fabricated as follows. First, for example, a negative electrode active material and a binder are mixed together to prepare a negative electrode mixture, and this negative electrode mixture is dispersed in a solvent such as N-methyl-2-pyrrolidone to prepare a paste-like negative electrode mixture slurry. Next, this negative electrode mixture slurry is applied to the negative electrode current collector 22A, the solvent is dried, compression molding is performed using a roll pressing machine or the like to form the negative electrode active material layer 22B, and the negative electrode 22 is thus obtained.

First, the positive electrode lead 25 is attached to the positive electrode current collector 21A by welding or the like, and the negative electrode lead 26 is attached to the negative electrode current collector 22A by welding or the like. Next, the positive electrode 21 and the negative electrode 22 are wound with the separator 23 interposed therebetween. Next, the tip of the positive electrode lead 25 is welded to the safety valve mechanism 15, the tip of the negative electrode lead 26 is welded to the battery can 11, and the wound positive electrode 21 and negative electrode 22 are sandwiched between a pair of insulating plates 12 and 13 and housed inside the battery can 11. Next, the electrolytic solution is injected into the battery can 11 and impregnated into the separator 23. Finally, the battery lid 14, the safety valve mechanism 15, and the positive temperature coefficient element 16 are fixed to the opening end portion of the battery can 11 by being crimped with the gasket 17 interposed therebetween. The battery illustrated in FIG. 1 is thus obtained.

The battery according to the first embodiment includes the positive electrode 21, the negative electrode 22, and an electrolytic solution. The positive electrode 21 has a positive electrode active material layer 21B containing a fluorine-based binder having a melting point of 166° C. or less. The content of the fluorine-based binder in the positive electrode active material layer 21B is 0.7% by mass or more and 2.8% by mass or less. The electrolytic solution contains a carboxylic acid ester, and the carboxylic acid ester has 4 or more and 10 or less carbon atoms. Favorable load characteristics can be thus attained. In addition, a high battery capacitance can be attained.

As the electrolytic solution contains a carbonic acid ester (carbonate-based solvent) and a carboxylic acid ester, it is possible to suppress swelling of the fluorine-based binder due to a carbonic acid ester and maintain the conductive network between the positive electrode active material grains. This effect is particularly remarkably exerted in a battery in which a fluorine-based binder having a melting point of 166° C. or less is used as a binder. exertion of such a remarkable effect is due to the following reasons. In other words, when a fluorine-based binder having a melting point of 166° C. or less is used as a binder of the positive electrode 21, a highly uniform binder layer is formed on the surface of the positive electrode active material grains. However, when such a highly uniform binder layer is formed, swelling of the binder causes significant inhibition of the conductive network. When the electrolytic solution contains a carboxylic acid ester as described above, such significant inhibition of the conductive network can be suppressed.

The binder with a low melting point has an advantage that the content of the positive electrode active material in the positive electrode active material layer can be increased and the capacitance of the battery can be increased since the surface of the positive electrode active material grains can be protected with a small amount of binder. As described above, in the battery according to the first embodiment, it is possible to suppress the inhibition of the conductive network between the positive electrode active material grains by swelling of the fluorine-based binder and thus the above-mentioned effect of increasing the capacitance can be sufficiently exerted.

In contrast, in Patent Document 1, the electrolytic solution is formed of a single solvent of carbonic acid ester (carbonate-based solvent) and thus the fluorine-based binder is likely to swell. For this reason, the conductive network between the positive electrode active material grains may be inhibited, the resistance of the battery may increase, and the load characteristics may be deteriorated. As a result, it is difficult to increase the capacitance of the battery.

In the present embodiment, a so-called cylindrical type battery has been described, but the present invention is also applicable to a laminate type battery as described in the second embodiment. In that case, a stacked type electrode body in which a positive electrode and a negative electrode are stacked with a separator interposed therebetween may be used instead of the wound type electrode body.

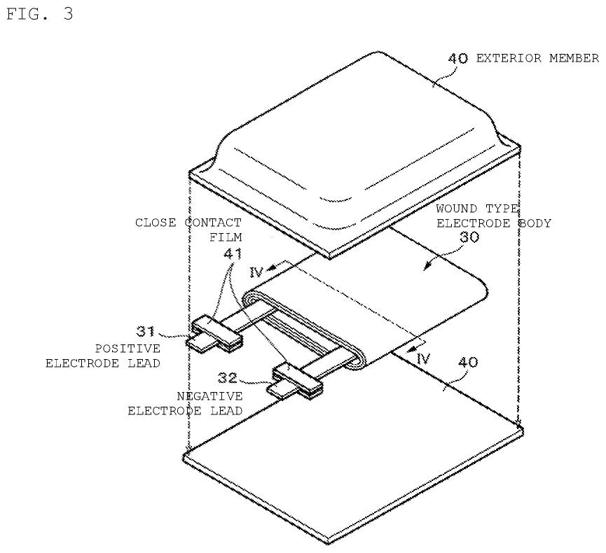

FIG. 3 illustrates an example of the configuration of a non-aqueous electrolyte secondary battery according to a second embodiment of the present invention. The battery according to the second embodiment is a so-called laminate type battery, a wound type electrode body 30 to which a positive electrode lead 31 and a negative electrode lead 32 are attached is housed inside a film-like exterior member 40 in the battery, and miniaturization, weight saving, and thinning of the battery are possible.

The positive electrode lead 31 and the negative electrode lead 32 are both led out, for example, in the same direction from the inside to the outside of the exterior member 40. The positive electrode lead 31 and the negative electrode lead 32 are each formed of a metal material such as aluminum, copper, nickel, or stainless steel and each have a thin plate shape or a mesh shape.

The exterior member 40 is formed of, for example, a rectangular aluminum laminate film in which a nylon film, an aluminum foil, and a polyethylene film are bonded to each other in this order. The exterior member 40 is arranged so that, for example, the polyethylene film side and the wound type electrode body 30 face each other, and the respective outer edge portions are in close contact with each other by sealing or an adhesive. A close contact film 41 is inserted between the exterior member 40 and the positive electrode lead 31 and between the exterior member 40 and the negative electrode lead 32 in order to prevent intrusion of outside air. The close contact film 41 is formed of a material exhibiting close contact property to the positive electrode lead 31 and the negative electrode lead 32, for example, a polyolefin resin such as polyethylene, polypropylene, modified polyethylene, or modified polypropylene.

The exterior member 40 may be formed of a laminate film having another structure, a polymer film such as polypropylene, or a metal film instead of the above-described laminate film. Alternatively, a laminate film in which a polymer film is laminated on one surface or both surfaces of an aluminum film as a core material may be used.

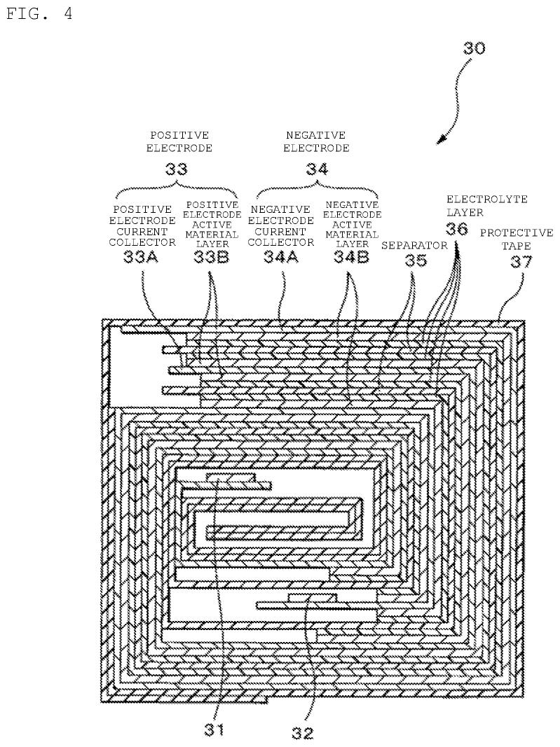

FIG. 4 is a sectional view of the wound type electrode body 30 illustrated in FIG. 3 taken along a line The wound type electrode body 30 is formed by laminating a positive electrode 33 and a negative electrode 34 with a separator 35 and an electrolyte layer 36 interposed therebetween and winding these, and the outermost peripheral portion thereof is protected by a protective tape 37.

The positive electrode 33 has a structure in which a positive electrode active material layer 33B is provided on one surface or both surfaces of a positive electrode current collector 33A. The negative electrode 34 has a structure in which a negative electrode active material layer 34B is provided on one surface or both surfaces of a negative electrode current collector 34A and is disposed so that the negative electrode active material layer 34B and the positive electrode active material layer 33B face each other. The configurations of the positive electrode current collector 33A, the positive electrode active material layer 33B, the negative electrode current collector 34A, the negative electrode active material layer 34B, and the separator 35 are similar to those of the positive electrode current collector 21A, the positive electrode active material layer 21B, the negative electrode current collector 22A, the negative electrode active material layer 22B, and the separator 23 in the first embodiment, respectively.

The electrolyte layer 36 contains an electrolytic solution and a polymer compound serving as a retainer for retaining this electrolytic solution and is in a so-called gel form. The gel-like electrolyte layer 36 is preferable since a high ionic conductivity can be attained and liquid leakage from the battery can be prevented. The electrolytic solution is the electrolytic solution according to the first embodiment. Examples of the polymer compound include polyacrylonitrile, polyvinylidene fluoride, a copolymer of vinylidene fluoride and hexafluoropropylene, polytetrafluoroethylene, polyhexafluoropropylene, polyethylene oxide, polypropylene oxide, polyphosphazene, polysiloxane, polyvinyl acetate, polyvinyl alcohol, polymethyl methacrylate, polyacrylic acid, polymethacrylic acid, styrene-butadiene rubber, nitrile-butadiene rubber, polystyrene, or polycarbonate. Particularly from the viewpoint of electrochemical stability, polyacrylonitrile, polyvinylidene fluoride, polyhexafluoropropylene, or polyethylene oxide is preferable.

The electrolyte layer 36 may contain inorganic grains. This is because the heat resistance can be further improved. As the inorganic grains, inorganic grains similar to those contained in the surface layer of the separator 23 of the first embodiment can be used. An electrolytic solution may be used instead of the electrolyte layer 36. A stacked type electrode body in which a positive electrode and a negative electrode are stacked with a separator interposed therebetween may be used instead of the wound type electrode body 30.

Next, an example of the method for manufacturing the battery according to the second embodiment of the present invention will be described.

First, a precursor solution containing a solvent, an electrolyte salt, a polymer compound, and a mixed solvent is applied to each of the positive electrode 33 and the negative electrode 34 and the mixed solvent is volatilized to form the electrolyte layer 36. Next, the positive electrode lead 31 is attached to the end portion of the positive electrode current collector 33A by welding and the negative electrode lead 32 is attached to the end portion of the negative electrode current collector 34A by welding. Next, the positive electrode 33 and negative electrode 34 on which the electrolyte layer 36 has been formed are stacked with the separator 35 interposed therebetween to form a stacked body, and then this stacked body is wound in its longitudinal direction, and the protective tape 37 is pasted to the outermost peripheral portion to form the wound type electrode body 30. Finally, for example, the wound type electrode body 30 is sandwiched between the exterior members 40 and encapsulated by bringing the outer edge portions of the exterior members 40 into close contact with each other by heat seal or the like. At that time, the close contact film 41 is inserted between the positive electrode lead 31 and the exterior member 40 and between the negative electrode lead 32 and the exterior member 40. The battery illustrated in FIGS. 3 and 4 is thus obtained.

This battery may be fabricated as follows. First, the positive electrode 33 and the negative electrode 34 are fabricated as described above, and the positive electrode lead 31 and the negative electrode lead 32 are attached to the positive electrode 33 and the negative electrode 34, respectively. Next, the positive electrode 33 and the negative electrode 34 are stacked with the separator 35 interposed therebetween and wound, and the protective tape 37 is pasted to the outermost peripheral portion to form a wound body. Next, this wound body is sandwiched between the exterior members 40, the outer peripheral edge portions excluding that of one side are heat-sealed to form a bag shape, and the wound body is thus housed inside the exterior member 40. Next, a composition for electrolyte containing a solvent, an electrolyte salt, a monomer which is a raw material for a polymer compound, a polymerization initiator, and if necessary, other materials such as a polymerization inhibitor is prepared and injected into the exterior member 40.

Next, the opening of the exterior member 40 is hermetically sealed by heat seal in a vacuum atmosphere. Next, the monomers are polymerized to a polymer compound by applying heat, a gel-like electrolyte layer 36 is thus formed. The battery illustrated in FIGS. 3 and 4 is thus obtained.

In the battery according to the second embodiment, the following effects can be attained in addition to the effects similar to those in the first embodiment. In other words, it is possible to suppress swelling of the battery (specifically, swelling of the exterior member 40) due to the generation of gas by covering the surface of the positive electrode active material grains with a highly uniform binder layer and thus suppressing the reaction between the positive electrode active material grains and the electrolytic solution.

In the application example 1, a battery pack and an electronic device which include the battery according to the above-described first or second embodiment will be described.

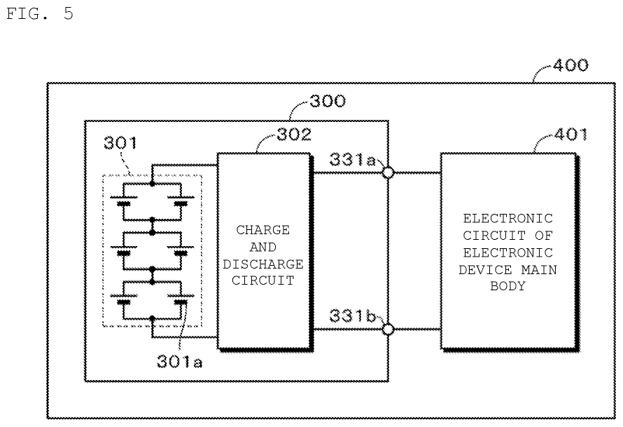

FIG. 5 illustrates an example of the configurations of a battery pack 300 and an electronic device 400 as an application example. The electronic device 400 includes an electronic circuit 401 of the electronic device main body and the battery pack 300. The battery pack 300 is electrically connected to the electronic circuit 401 via a positive electrode terminal 331a and a negative electrode terminal 331b. The electronic device 400 has, for example, a configuration in which the battery pack 300 is freely attached and detached by the user. The configuration of the electronic device 400 is not limited to this, and the electronic device 400 may have a configuration in which the battery pack 300 is built in the electronic device 400 so that the user cannot be detached the battery pack 300 from the electronic device 400.

When the battery pack 300 is charged, the positive electrode terminal 331a and negative electrode terminal 331b of the battery pack 300 are connected to the positive electrode terminal and negative electrode terminal of a charger (not illustrated), respectively. On the other hand, when the battery pack 300 is discharged (when the electronic device 400 is used), the positive electrode terminal 331a and negative electrode terminal 331b of the battery pack 300 are connected to the positive electrode terminal and negative electrode terminal of the electronic circuit 401, respectively.

Examples of the electronic device 400 include laptop personal computers, tablet computers, mobile phones (for example, smartphones), personal digital assistants (PDA), display devices (LCD, EL display, electronic paper and the like), imaging devices (for example, digital still cameras, digital video cameras and the like), audio devices (for example, portable audio players), game consoles, cordless phones, e-books, electronic dictionaries, radios, headphones, navigation systems, memory cards, pacemakers, hearing aids, electric power tools, electric shavers, refrigerators, air conditioners, TVs, stereos, water heaters, microwave ovens, dishwashers, washing machines, dryers, lighting equipment, toys, medical equipment, robots, road conditioners, and traffic lights, but the electronic device 400 is not limited thereto.

The electronic circuit 401 includes, for example, a CPU, a peripheral logic unit, an interface unit, a storage unit, and the like and controls the entire electronic device 400.

The battery pack 300 includes an assembled battery 301 and a charge and discharge circuit 302. The assembled battery 301 is configured by connecting a plurality of secondary batteries 301a in series and/or in parallel. The plurality of secondary batteries 301a are connected, for example, n in parallel and m in series (n and m are positive integers). FIG. 5 illustrates an example in which six secondary batteries 301a are connected two in parallel and three in series (2P3S). As the secondary battery 301a, the battery according to the first or second embodiment described above is used.

Here, a case in which the battery pack 300 includes the assembled battery 301 including the plurality of secondary batteries 301a is described, but a configuration in which the battery pack 300 includes one secondary battery 301a instead of the assembled battery 301 may be adopted.

The charge and discharge circuit 302 is a control unit (controller) which controls charge and discharge of the assembled battery 301. Specifically, the charge and discharge circuit 302 controls charge of the assembled battery 301 at the time of charge. On the other hand, the charge and discharge circuit 302 controls discharge of the electronic device 400 at the time of discharge (that is, when the electronic device 400 is used). The charge and discharge circuit (controller) 302 may include a processor or the like.

In the application example 2, a power storage system for an electrically driven vehicle which includes the battery according to the above-described first or second embodiment will be described.

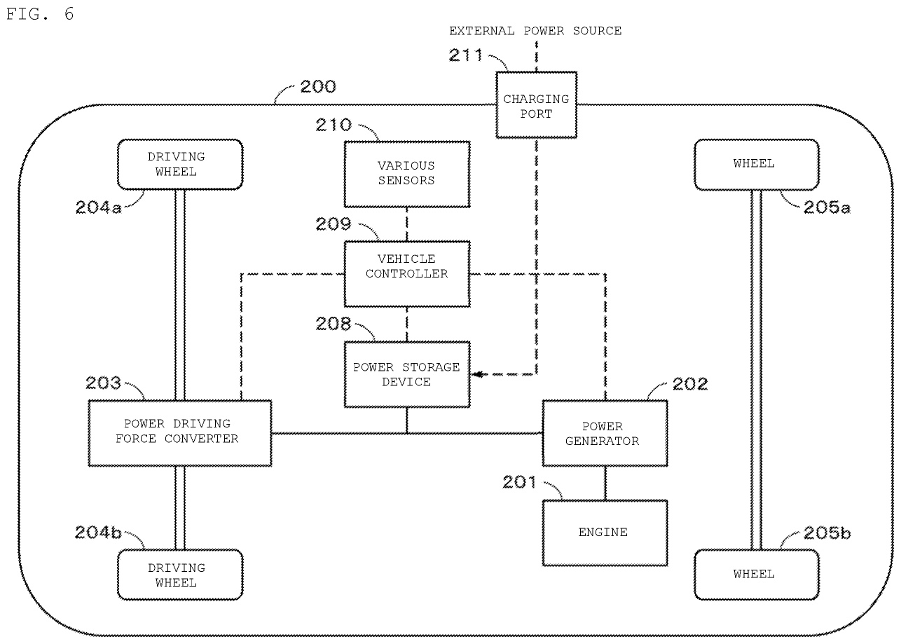

FIG. 6 schematically illustrates the configuration of a hybrid vehicle that employs a series hybrid system as a power storage system for an electrically driven vehicle. The series hybrid system is a system which runs by a power driving force converter using the power generated by a power generator operated by an engine or the power temporarily stored in a battery.

This hybrid vehicle 200 is equipped with an engine 201, a power generator 202, a power driving force converter 203, a driving wheel 204a, a driving wheel 204b, a wheel 205a, a wheel 205b, a power storage device 208, a vehicle controller 209, various sensors 210, and a charging port 211. The power storage device 208 includes one or two or more batteries according to the first or second embodiment described above.

The hybrid vehicle 200 runs by using the power driving force converter 203 as a power source. An example of the power driving force converter 203 is a motor. The power driving force converter 203 is operated by the power of the power storage device 208, and the rotational force of this power driving force converter 203 is transmitted to the driving wheels 204a and 204b. Both an alternating current motor and a direct current motor can be used as the power driving force converter 203 by using direct current-alternating current (DC-AC) conversion or inverse conversion (AC-DC conversion) at the necessary place. The various sensors 210 control the engine speed through the vehicle controller 209 and control the opening degree (throttle opening degree) of a throttle valve (not illustrated). The various sensors 210 include a speed sensor, an acceleration sensor, an engine rpm sensor, and the like.

The rotational force of the engine 201 is transmitted to the power generator 202, and the power generated by the power generator 202 can be stored in the power storage device 208 by the rotational force.

When the hybrid vehicle decelerates by a braking mechanism (not illustrated), the resistance force at the time of the deceleration is applied to the power driving force converter 203 as a rotational force, and the regenerative power generated by the power driving force converter 203 from this rotational force is stored in the power storage device 208.

As the power storage device 208 is connected to an external power source through the charging port 211, the power storage device 208 can receive power supply from the external power source using the charging port 211 as an input port and can also store the received power.

Although it is not illustrated, an information processing device which performs information processing about vehicle control based on the information about the secondary battery may be provided. As such an information processing device, for example, there is an information processing device which displays the residual battery quantity based on the information about the residual capacitance of the battery.

In the above-described application example, a series hybrid vehicle which runs by a motor using the power generated by a power generator operated by an engine or the power temporarily stored in a battery has been described as an example, but the vehicle which can use the battery according to the present invention is not limited to this. The vehicle may be, for example, a parallel hybrid vehicle which uses an engine and a motor as drive sources and appropriately switches three modes of running by only the engine, running by only the motor, and running by the engine and the motor or an electrically driven vehicle which runs by being driven only by a drive motor without using an engine.

In the above-described application example, a case in which the power storage system is a power storage system for vehicles has been described, but the power storage system which can use the battery according to the present invention is not limited to this and may be, for example, a power storage system for residential use or industrial use.

Hereinafter, the present invention will be specifically described with reference to

Examples, but the present invention is not limited only to these Examples.

In Examples, the melting point of the binder and the volume density of the positive electrode active material layer are values determined by the measuring methods described in the first embodiment.

### EXAMPLES AND COMPARATIVE EXAMPLES IN WHICH MELTING POINT AND CONTENT OF FLUORINE-BASED BINDER, COMPOSITION OF ELECTROLYTIC SOLUTION, AND NUMBER OF CARBON ATOMS IN CARBOXYLIC ACID ESTER ARE CHANGED

### Example 1-1

The positive electrode was fabricated as follows. A positive electrode mixture was obtained by mixing 98.1% by mass of lithium-cobalt composite oxide (LiCoO₂) as a positive electrode active material, 1.4% by mass of polyvinylidene fluoride (homopolymer of vinylidene fluoride) having a melting point of 155° C. as a binder, and 0.5% by mass of carbon black as a conductive agent, and then this positive electrode mixture was dispersed in an organic solvent (N-methyl-2-pyrrolidone: NMP) to obtain a paste-like positive electrode mixture slurry. Subsequently, the positive electrode current collector (aluminum foil) was coated with the positive electrode mixture slurry using a coating apparatus and then dried to form a positive electrode active material layer. In this drying step, the binder melts and the active material surface is covered. Finally, the positive electrode active material layer was compression-molded using a pressing machine until the volume density reached 4.0 g/cm³.

The negative electrode was fabricated as follows. First, a negative electrode mixture was obtained by mixing 96% by mass of artificial graphite powder as a negative electrode active material, 1% by mass of styrene-butadiene rubber (SBR) as a first binder, 2% by mass of polyvinylidene fluoride (PVdF) as a second binder, and 1% by mass of carboxymethyl cellulose (CMC) as a thickener, and then this negative electrode mixture was dispersed in an organic solvent (N-methyl-2-pyrrolidone: NMP) to obtain a paste-like negative electrode mixture slurry. Subsequently, the negative electrode current collector (copper foil) was coated with the negative electrode mixture slurry using a coating apparatus and then dried. Finally, the negative electrode active material layer was compression-molded using a pressing machine.

The electrolytic solution was prepared as follows. First, a mixed solvent was prepared by mixing EC, PC, and ethyl acetate so as to have a volume ratio of EC:PC:ethyl acetate=11:9:80. Subsequently, an electrolytic solution was prepared by dissolving lithium hexafluorophosphate (LiPF₆) as an electrolyte salt in this mixed solvent so as to have a concentration of 1 mol/l.

A laminate type battery was fabricated as follows. First, an aluminum positive electrode lead was welded to the positive electrode current collector, and a copper negative electrode lead was welded to the negative electrode current collector. Subsequently, the positive electrode and the negative electrode were brought into close contact with each other with a microporous polyethylene film interposed therebetween and then wound in the longitudinal direction, and a protective tape was attached to the outermost peripheral portion to fabricate a flat-shaped wound electrode body. Next, this wound electrode body was loaded between the exterior members, and three sides of the exterior members were heat-sealed, and one side was not heat-sealed but was open. As the exterior member, a moistureproof aluminum laminate film in which a 25 μm thick nylon film, a 40 μm thick aluminum foil, and a 30 μm thick polypropylene film were laminated in this order from the outermost layer was used.

Thereafter, the electrolytic solution was injected through the opening of the exterior member, and the remaining one side of the exterior member was heat-sealed under reduced pressure to hermetically seal the wound electrode body. The intended laminate type battery was thus obtained.

### Example 1-2

A battery was obtained in the same manner as in Example 1-1 except that a mixed solvent was prepared by mixing EC, PC, and ethyl propionate so as to have a volume ratio of EC:PC:ethyl propionate=11:9:80 in the step of preparing the electrolytic solution.

### Example 1-3

A battery was obtained in the same manner as in Example 1-1 except that a mixed solvent was prepared by mixing EC, PC, and propyl propionate so as to have a volume ratio of EC:PC:propyl propionate=11:9:80 in the step of preparing the electrolytic solution.

### Example 1-4

A battery was obtained in the same manner as in Example 1-1 except that a mixed solvent was prepared by mixing EC, PC, and butyl butyrate so as to have a volume ratio of EC:PC:butyl butyrate=11:9:80 in the step of preparing the electrolytic solution.

### Example 1-5

A battery was obtained in the same manner as in Example 1-1 except that a mixed solvent was prepared by mixing EC, PC, and hexyl butyrate so as to have a volume ratio of EC:PC:hexyl butyrate=11:9:80 in the step of preparing the electrolytic solution.

### Comparative Example 1-1

A battery was obtained in the same manner as in Example 1-1 except that a mixed solvent was prepared by mixing EC, PC, and ethyl formate so as to have a volume ratio of EC:PC:ethyl formate=11:9:80 in the step of preparing the electrolytic solution.

### Comparative Example 1-2

A battery was obtained in the same manner as in Example 1-1 except that a mixed solvent was prepared by mixing EC, PC, and butyl octanoate so as to have a volume ratio of EC:PC:butyl octanoate=11:9:80 in the step of preparing the electrolytic solution.

### Comparative Example 1-3

A battery was obtained in the same manner as in Example 1-1 except that EC, PC, DMC, DEC, and EMC were set to EC:PC:DMC:DEC:EMC=11:9:47:4:29 in the step of preparing the electrolytic solution.

### Examples 2-1 to 2-5 and Comparative Examples 2-1 to 2-3

Batteries were obtained in the same manner as in Examples 1-1 to 1-5 and Comparative Examples 1-1 to 1-3 except that polyvinylidene fluoride (homopolymer of vinylidene fluoride) having a melting point of 166° C. was used as a binder in the step of fabricating the positive electrode.

### Comparative Examples 3-1 to 3-8

Batteries were obtained in the same manner as in Examples 1-1 to 1-5 and Comparative Examples 1-1 to 1-3 except that a positive electrode mixture was obtained by mixing 99.1% by mass of lithium-cobalt composite oxide (LiCoO2) as a positive electrode active material, 0.4% by mass of polyvinylidene fluoride (homopolymer of vinylidene fluoride) having a melting point of 166° C. as a binder, and 0.5% by mass of carbon black as a conductive agent.

### Examples 4-1 to 4-5 and Comparative Examples 4-1 to 4-3

Batteries were obtained in the same manner as in Examples 1-1 to 1-5 and Comparative Examples 1-1 to 1-3 except that a positive electrode mixture was obtained by mixing 98.8% by mass of lithium-cobalt composite oxide (LiCoO₂) as a positive electrode active material, 0.7% by mass of polyvinylidene fluoride (homopolymer of vinylidene fluoride) having a melting point of 166° C. as a binder, and 0.5% by mass of carbon black as a conductive agent.

### Examples 5-1 to 5-5 and Comparative Examples 5-1 to 5-3

Batteries were obtained in the same manner as in Examples 1-1 to 1-5 and Comparative Examples 1-1 to 1-3 except that a positive electrode mixture was obtained by mixing 96.7% by mass of lithium-cobalt composite oxide (LiCoO₂) as a positive electrode active material, 2.8% by mass of polyvinylidene fluoride (homopolymer of vinylidene fluoride) having a melting point of 166° C. as a binder, and 0.5% by mass of carbon black as a conductive agent.

### Comparative Examples 6-1 to 6-8

Batteries were obtained in the same manner as in Examples 1-1 to 1-5 and Comparative Examples 1-1 to 1-3 except that a positive electrode mixture was obtained by mixing 96.5% by mass of lithium-cobalt composite oxide (LiCoO₂) as a positive electrode active material, 3.0% by mass of polyvinylidene fluoride (homopolymer of vinylidene fluoride) having a melting point of 166° C. as a binder, and 0.5% by mass of carbon black as a conductive agent.

### Example 7-1

A battery was obtained in the same manner as in Example 2-1 except that a mixed solvent was prepared by mixing EC, PC, DEC, and ethyl acetate so as to have a volume ratio of EC:PC:DEC:ethyl acetate=11:9:20:60 in the step of preparing the electrolytic solution.

### Example 7-2

A battery was obtained in the same manner as in Example 2-1 except that a mixed solvent was prepared by mixing EC, PC, DEC, and ethyl acetate so as to have a volume ratio of EC:PC:DEC:ethyl acetate=11:9:40:40 in the step of preparing the electrolytic solution.

### Example 7-3

A battery was obtained in the same manner as in Example 2-2 except that a mixed solvent was prepared by mixing EC, PC, DEC, and ethyl propionate so as to have a volume ratio of EC:PC:DEC:ethyl propionate=11:9:20:60 in the step of preparing the electrolytic solution.

### Example 7-4

A battery was obtained in the same manner as in Example 2-2 except that a mixed solvent was prepared by mixing EC, PC, DEC, and ethyl propionate so as to have a volume ratio of EC:PC:DEC:ethyl propionate=11:9:40:40 in the step of preparing the electrolytic solution.

### Example 7-5

A battery was obtained in the same manner as in Example 2-3 except that a mixed solvent was prepared by mixing EC, PC, DEC, and propyl propionate so as to have a volume ratio of EC:PC:DEC: propyl propionate=11:9:20:60 in the step of preparing the electrolytic solution.

### Example 7-6

A battery was obtained in the same manner as in Example 2-3 except that a mixed solvent was prepared by mixing EC, PC, DEC, and propyl propionate so as to have a volume ratio of EC:PC:DEC:propyl propionate=11:9:40:40 in the step of preparing the electrolytic solution.

### Example 7-7

A battery was obtained in the same manner as in Example 2-4 except that a mixed solvent was prepared by mixing EC, PC, DEC, and butyl butyrate so as to have a volume ratio of EC:PC:DEC:butyl butyrate=11:9:20:60 in the step of preparing the electrolytic solution.

### Example 7-8

A battery was obtained in the same manner as in Example 2-4 except that a mixed solvent was prepared by mixing EC, PC, DEC, and butyl butyrate so as to have a volume ratio of EC:PC:DEC:butyl butyrate=11:9:40:40 in the step of preparing the electrolytic solution.

### Example 7-9

A battery was obtained in the same manner as in Example 2-5 except that a mixed solvent was prepared by mixing EC, PC, DEC, and hexyl butyrate so as to have a volume ratio of EC:PC:DEC:hexyl butyrate=11:9:20:60 in the step of preparing the electrolytic solution.

### Example 7-10

A battery was obtained in the same manner as in Example 2-5 except that a mixed solvent was prepared by mixing EC, PC, DEC, and hexyl butyrate so as to have a volume ratio of EC:PC:DEC:hexyl butyrate=11:9:40:40 in the step of preparing the electrolytic solution.

### Comparative Example 7-1

A battery was obtained in the same manner as in Comparative Example 2-2 except that a mixed solvent was prepared by mixing EC, PC, DEC, and butyl octanoate so as to have a volume ratio of EC:PC:DEC:butyl octanoate=11:9:20:60 in the step of preparing the electrolytic solution.

### Comparative Example 7-2

A battery was obtained in the same manner as in Comparative Example 2-2 except that a mixed solvent was prepared by mixing EC, PC, DEC, and butyl octanoate so as to have a volume ratio of EC:PC:DEC:butyl octanoate=11:9:40:40 in the step of preparing the electrolytic solution.

### Examples 8-1 to 8-7

Batteries were obtained in the same manner as in Example 2-2 except that ethyl isobutyrate, methyl butyrate, ethyl pivalate, isopropyl propionate, tert-butyl propionate, ethyl caproate, or ethyl octanoate was used instead of ethyl acetate in the step of preparing the electrolytic solution.

### Examples 9-1 to 9-5

Batteries were obtained in the same manner as in Examples 2-1 to 2-5 except that only EC was used as carbonic acid ester instead of using EC and PC as carbonic acid esters in the step of preparing the electrolytic solution.

### (Load Characteristics)

The batteries obtained as described above were subjected to the evaluation on load characteristics (discharge rate characteristics) as follows. First, the battery was allowed to stand in an environment of 23° C. until the temperature of the battery was stabilized, then the battery was charged to 4.4 V, and then the battery was discharged to 3.0 V at a current of 1 C and 23° C. Next, the battery was allowed to stand at 23° C. again, then charged to 4.4 V, and then discharged to 3.0 V at a current of 0.2 C. Next, the ratio of 1 C discharge capacitance to 0.2 C discharge capacitance (=(1 C discharge capacitance)÷(0.2 C discharge capacitance)×100) was determined, and the determined ratio was taken as the discharge rate characteristic. Incidentally, the “current of 1 C ” is a current value at which the rated capacitance is fully discharged in 1 hour, and the “current of 0.2 C ” is a current value at which the rated capacitance is fully discharged in 5 hours.

Table 1 presents the configurations and evaluation results of the batteries in Examples 1-1 to 1-5 and 2-1 to 2-5 and Comparative Examples 1-1 to 1-3 and 2-1 to 2-3.

TABLE 1

| | | | | Solvent | | | |
|---|---|---|---|---|---|---|---|
| | | | | | | Number of | |
| | Melting | Content | Volume | | | carbon atoms | Load |
| | point of | of binder | density | Carbonic acid | Carboxylic acid | in carboxylic | characteristic |
| | binder | [% by mass] | [g/cm³] | ester [vol %] | ester [vol %] | acid ester | [%] |
| Comparative | 155 | 1.4 | 4.0 | EC:PC = 11:9 | Ethyl formate (80) | 3 | 51 |
| Example 1-1 | | | | | | | |
| Example 1-1 | | | | EC:PC = 11:9 | Ethyl acetate (80) | 4 | 93 |
| Example 1-2 | | | | EC:PC = 11:9 | Ethyl propionate (80) | 5 | 93 |
| Example 1-3 | | | | EC:PC = 11:9 | Propyl propionate (80) | 6 | 89 |
| Example 1-4 | | | | EC:PC = 11:9 | Butyl butyrate (80) | 8 | 86 |
| Example 1-5 | | | | EC:PC = 11:9 | Hexyl butyrate (80) | 10 | 84 |
| Comparative | 166 | 1.4 | 4.0 | EC:PC = 11:9 | Butyl octanoate (80) | 12 | 79 |
| Example 1-2 | | | | | | | |
| Comparative | | | | EC:PC:DMC:DEC:EMC = | — | — | 70 |
| Example 1-3 | | | | 11:9:47:4:29 | | | |
| Comparative | | | | EC:PC = 11:9 | Ethyl formate (80) | 3 | 49 |
| Example 2-1 | | | | | | | |
| Example 2-1 | | | | EC:PC = 11:9 | Ethyl acetate (80) | 4 | 93 |
| Example 2-2 | | | | EC:PC = 11:9 | Ethyl propionate (80) | 5 | 94 |
| Example 2-3 | | | | EC:PC = 11:9 | Propyl propionate (80) | 6 | 90 |
| Example 2-4 | | | | EC:PC = 11:9 | Butyl butyrate (80) | 8 | 84 |
| Example 2-5 | | | | EC:PC = 11:9 | Hexyl butyrate (80) | 10 | 85 |
| Comparative | | | | EC:PC = 11:9 | Butyl octanoate (80) | 12 | 78 |
| Example 2-2 | | | | | | | |
| Comparative | | | | EC:PC:DMC:DEC:EMC = | — | — | 69 |
| Example 2-3 | | | | 11:9:47:4:29 | | | |

Table 2 presents the configurations and evaluation results of the batteries in Examples 4-1 to 4-5 and 5-1 to 5-5 and Comparative Examples 3-1 to 3-8, 4-1 to 4-3, 5-1 to 5-3, and 6-1 to 6-8.

TABLE 2

| | | | | Solvent | | | |
|---|---|---|---|---|---|---|---|
| | | | | | | Number of | |
| | Melting | Content | Volume | | | carbon atoms | Load |
| | point of | of binder | density | Carbonic acid | Carboxylic acid | in carboxylic | characteristic |
| | binder | [% by mass] | [g/cm³] | ester [vol %] | ester [vol %] | acid ester | [%] |
| Comparative | 166 | 0.4 | 4.0 | EC:PC = 11:9 | Ethyl formate (80) | 3 | 43 |
| Example 3-1 | | | | | | | |
| Comparative | | | | EC:PC = 11:9 | Ethyl acetate (80) | 4 | 79 |
| Example 3-2 | | | | | | | |
| Comparative | | | | EC:PC = 11:9 | Ethyl propionate (80) | 5 | 76 |
| Example 3-3 | | | | | | | |
| Comparative | | | | EC:PC = 11:9 | Propyl propionate (80) | 6 | 76 |
| Example 3-4 | | | | | | | |
| Comparative | | | | EC:PC = 11:9 | Butyl butyrate (80) | 8 | 72 |
| Example 3-5 | | | | | | | |
| Comparative | | | | EC:PC = 11:9 | Hexyl butyrate (80) | 10 | 70 |
| Example 3-6 | | | | | | | |
| Comparative | | | | EC:PC = 11:9 | Butyl octanoate (80) | 12 | 61 |
| Example 3-7 | | | | | | | |
| Comparative | | | | EC:PC:DMC:DEC:EMC = | — | — | 63 |
| Example 3-8 | | | | 11:9:47:4:29 | | | |
| Comparative | 166 | 0.7 | 4.0 | EC:PC = 11:9 | Ethyl formate (80) | 3 | 49 |
| Example 4-1 | | | | | | | |
| Example 4-1 | | | | EC:PC = 11:9 | Ethyl acetate (80) | 4 | 93 |
| Example 4-2 | | | | EC:PC = 11:9 | Ethyl propionate (80) | 5 | 93 |
| Example 4-3 | | | | EC:PC = 11:9 | Propyl propionate (80) | 6 | 91 |
| Example 4-4 | | | | EC:PC = 11:9 | Butyl butyrate (80) | 8 | 86 |
| Example 4-5 | | | | EC:PC = 11:9 | Hexyl butyrate (80) | 10 | 86 |
| Comparative | | | | EC:PC = 11:9 | Butyl octanoate (80) | 12 | 77 |
| Example 4-2 | | | | | | | |
| Comparative | | | | EC:PC:DMC:DEC:EMC = | — | — | 74 |
| Example 4-3 | | | | 11:9:47:4:29 | | | |
| Comparative | 166 | 2.8 | 4.0 | EC:PC = 11:9 | Ethyl formate (80) | 3 | 49 |
| Example 5-1 | | | | | | | |
| Example 5-1 | | | | EC:PC = 11:9 | Ethyl acetate (80) | 4 | 93 |
| Example 5-2 | | | | EC:PC = 11:9 | Ethyl propionate (80) | 5 | 94 |
| Example 5-3 | | | | EC:PC = 11:9 | Propyl propionate (80) | 6 | 90 |
| Example 5-4 | | | | EC:PC = 11:9 | Butyl butyrate (80) | 8 | 84 |
| Example 5-5 | | | | EC:PC = 11:9 | Hexyl butyrate (80) | 10 | 85 |
| Comparative | | | | EC:PC = 11:9 | Butyl octanoate (80) | 12 | 78 |
| Example 5-2 | | | | | | | |
| Comparative | 166 | 3.0 | 4.0 | EC:PC:DMC:DEC:EMC = | — | — | 69 |
| Example 5-3 | | | | 11:9:47:4:29 | | | |
| Comparative | | | | EC:PC = 11:9 | Ethyl formate (80) | 3 | 45 |
| Example 6-1 | | | | | | | |
| Comparative | | | | EC:PC = 11:9 | Ethyl acetate (80) | 4 | 72 |
| Example 6-2 | | | | | | | |
| Comparative | | | | EC:PC = 11:9 | Ethyl propionate (80) | 5 | 72 |
| Example 6-3 | | | | | | | |
| Comparative | | | | EC:PC = 11:9 | Propyl propionate (80) | 6 | 70 |
| Example 6-4 | | | | | | | |
| Comparative | | | | EC:PC = 11:9 | Butyl butyrate (80) | 8 | 68 |
| Example 6-5 | | | | | | | |
| Comparative | | | | EC:PC = 11:9 | Hexyl butyrate (80) | 10 | 66 |
| Example 6-6 | | | | | | | |
| Comparative | | | | EC:PC = 11:9 | Butyl octanoate (80) | 12 | 60 |
| Example 6-7 | | | | | | | |
| Comparative | | | | EC:PC:DMC:DEC:EMC = | — | — | 42 |
| Example 6-8 | | | | 11:9:47:4:29 | | | |

Table 3 presents the configurations and evaluation results of the batteries in Examples 2-1 to 2-5 and 7-1 to 7-10 and Comparative Examples 2-2, 7-1, and 7-2.

TABLE 3

| | | | | Solvent | | | |
|---|---|---|---|---|---|---|---|
| | | | | | | Number of | |
| | Melting | Content | Volume | | | carbon atoms | Load |
| | point of | of binder | density | Carbonic acid | Carboxylic acid | in carboxylic | characteristic |
| | binder | [% by mass] | [g/cm³] | ester [vol %] | ester [vol %] | acid ester | [%] |
| Example 2-1 | 166 | 1.4 | 4.0 | EC:PC = 11:9 | Ethyl acetate (80) | 4 | 93 |
| Example 7-1 | | | | EC:PC:DEC = 11:9:20 | Ethyl acetate (60) | | 92 |
| Example 7-2 | | | | EC:PC:DEC = 11:9:40 | Ethyl acetate (40) | | 93 |
| Example 2-2 | | | | EC:PC = 11:9 | Ethyl propionate (80) | 5 | 94 |
| Example 7-3 | | | | EC:PC:DEC = 11:9:20 | Ethyl propionate (60) | | 92 |
| Example 7-4 | | | | EC:PC:DEC = 11:9:40 | Ethyl propionate (40) | | 91 |
| Example 2-3 | | | | EC:PC = 11:9 | Propyl propionate (80) | 6 | 90 |
| Example 7-5 | | | | EC:PC:DEC = 11:9:20 | Propyl propionate (60) | | 90 |
| Example 7-6 | | | | EC:PC:DEC = 11:9:40 | Propyl propionate (40) | | 91 |
| Example 2-4 | | | | EC:PC = 11:9 | Butyl butyrate (80) | 8 | 84 |
| Example 7-7 | | | | EC:PC:DEC = 11:9:20 | Butyl butyrate (60) | | 83 |
| Example 7-8 | | | | EC:PC:DEC = 11:9:40 | Butyl butyrate (40) | | 80 |
| Example 2-5 | | | | EC:PC = 11:9 | Hexyl butyrate (80) | 10 | 85 |
| Example 7-9 | | | | EC:PC:DEC = 11:9:20 | Hexyl butyrate (60) | | 85 |
| Example 7-10 | | | | EC:PC:DEC = 11:9:40 | Hexyl butyrate (40) | | 84 |
| Comparative | | | | EC:PC = 11:9 | Butyl octanoate (80) | 12 | 78 |
| Example 2-1 | | | | | | | |
| Comparative | | | | EC:PC:DEC = 11:9:20 | Butyl octanoate (60) | | 76 |
| Example 7-1 | | | | | | | |
| Comparative | | | | EC:PC:DEC = 11:9:40 | Butyl octanoate (40) | | 72 |
| Example 7-2 | | | | | | | |

Table 4 presents the configurations and evaluation results of the batteries in

Examples 8-1 to 8-7 and 9-1 to 9-5.

TABLE 4

| | | | | Solvent | | | |
|---|---|---|---|---|---|---|---|
| | | | | | | Number of | |
| | Melting | Content | Volume | | | carbon atoms | Load |
| | point of | of binder | density | Carbonic acid | Carboxylic acid | in carboxylic | characteristic |
| | binder | [% by mass] | [g/cm³] | ester [vol %] | ester [vol %] | acid ester | [%] |
| Example 2-1 | 166 | 1.4 | 4.0 | EC/PC = 11/9 | Ethyl acetate (80) | 4 | 93 |
| Example 8-1 | | | | EC/PC = 11/9 | Ethyl isobutyrate (80) | 6 | 92 |
| Example 8-2 | | | | EC/PC = 11/9 | Ethyl butyrate (80) | 5 | 89 |
| Example 8-3 | | | | EC/PC = 11/9 | Ethyl pivalate (80) | 6 | 88 |
| Example 8-4 | | | | EC/PC = 11/9 | Isopropyl propionate (80) | 6 | 89 |
| Example 8-5 | | | | EC/PC = 11/9 | tert-Butyl propionate (80) | 7 | 88 |
| Example 8-6 | | | | EC/PC = 11/9 | Ethyl caproate (80) | 8 | 86 |
| Example 8-7 | | | | EC/PC = 11/9 | Ethyl octoate (80) | 10 | 87 |
| Example 9-1 | 166 | 1.4 | 4.0 | EC (20) | Ethyl acetate (80) | 4 | 86 |
| Example 9-2 | | | | EC (20) | Ethyl propionate (80) | 5 | 93 |
| Example 9-3 | | | | EC (20) | Propyl propionate (80) | 6 | 90 |
| Example 9-4 | | | | EC (20) | Butyl butyrate (80) | 8 | 83 |
| Example 9-5 | | | | EC (20) | Hexyl butyrate (80) | 10 | 83 |

From the evaluation results in Examples 1-1 to 1-5, 2-1 to 2-5, 4-1 to 4-5, and 5-1 to 5-5, it can be seen that favorable load characteristics can be attained when (1) the positive electrode active material layer contains a fluorine-based binder (binder with low melting point) having a melting point of 166° C. or less, (2) the content of the fluorine-based binder in the positive electrode active material layer is within a range of 0.7% by mass or more and 2.8% by mass or less, (3) the electrolyte contains a carboxylic acid ester, and (4) the number of carbon atoms in the carboxylic acid ester is in a range of 4 or more and 10 or less.

From the evaluation results in Comparative Examples 3-1 to 3-8 and 6-1 to 6-8, it can be seen that favorable load characteristics cannot be attained when (2′) the content of the fluorine-based binder in the positive electrode active material layer is out of the range of 0.7% by mass or more and 2.8% by mass or less. This result is considered to be due to the following reasons. In other words, when the content of the fluorine-based binder is less than 0.7% by mass, the content of the fluorine-based binder is too low, it is impossible to sufficiently maintain the binding property between the positive electrode active material grains, thus independent positive electrode active material is generated, and the load characteristics are deteriorated. On the other hand, when the content of the fluorine-based binder exceeds 2.8% by mass, the content of the fluorine-based binder is too high, the transfer resistance of lithium ions increases, and the load characteristics are deteriorated.

From the evaluation results in Comparative Examples 1-3, 2-3, 4-3, and 5-3, it can be seen that favorable load characteristics cannot be attained when (3′) the electrolyte does not contain a carboxylic acid ester. This result is considered to be due to the following reasons. In other words, when an electrolytic solution containing only a carbonate-based solvent is used as the solvent, the fluorine-based bander swells, the conductive network of the positive electrode active material is inhibited, the resistance of the battery increases, and thus the load characteristics are deteriorated. Such deterioration in load characteristics is particularly remarkable in the positive electrode active material layer containing a fluorine-based binder (binder with low melting point) having a melting point of 166° C. or less. This is because when a binder with a low melting point is used, a highly uniform binder layer is formed on the surface of the positive electrode active material grains, thus the conductive network inhibition by swelling of the fluorine-based bander is remarkable, and the resistance of the battery tends to be particularly high.

In a battery containing a fluorine-based binder having a melting point of more than 166° C. (for example, a fluorine-based binder having a melting point of 172° C.) in the positive electrode active material layer, the effect of improving the load characteristics is minor even when an electrolytic solution containing a carboxylic acid ester is used. This is considered to be due to the following reasons. In other words, a fluorine-based binder having a melting point of more than 166° C. hardly melts when the positive electrode active material layer is subjected to a heat treatment, cannot uniformly cover the surface of the positive electrode active material grains, and is likely to sparsely exist on the surface. For this reason, the influence of swelling of the fluorine-based binder due to a carbonic acid ester is minor, and a difference in effect is hardly observed between a case in which an electrolytic solution not containing a carboxylic acid ester is used and a case in which an electrolytic solution containing a carboxylic acid ester is used.

From the evaluation results of Comparative Examples 1-1, 1-2, 2-1, 2-2, 4-1, 4-2, 5-1 and 5-2, it can be seen that favorable load characteristics cannot be attained when (4′) the number of carbon atoms in a carboxylic acid ester is out of the range of 4 or more and 10 or less. This result is considered to be due to the following reasons. When the carboxylic acid ester has 3 or less carbon atoms, the reactivity is high, thus the by-products during charge and discharge increase the electrode surface resistance, and the load characteristics are deteriorated. On the other hand, when the carboxylic acid ester has more than 10 carbon atoms, the viscosity of the electrolytic solution greatly increases due to an increase in the molecular weight, thus the transfer resistance of lithium ions increases, and the load characteristics are deteriorated.

From Examples 2-1 to 2-5, 7-1 to 7-10, 9-1 to 9-5 and Comparative Examples 2-2, 7-1, and 7-2, it can be seen that favorable load characteristics can be attained regardless of the kind of carbonic acid ester contained in the electrolytic solution as long as the above configurations (1) to (4) are satisfied.

From the evaluation results in Examples 8-1 to 8-7, it can be seen that favorable load characteristics can be attained as long as the number of carbon atoms in a carboxylic acid ester is within the range of 4 or more and 10 or less even when the carboxylic acid ester has a linear or branched structure on the carbonyl group side or the alkyl group side. EXAMPLES AND COMPARATIVE EXAMPLES IN WHICH VOLUME DENSITY OF POSITIVE ELECTRODE ACTIVE MATERIAL LAYER IS CHANGED

### Examples 10-1 to 10-5 and Comparative Example 10-1

Batteries were obtained in the same manner as in Examples 2-1 to 2-5 except that the positive electrode active material layer was compression-molded until to have a volume density of 3.7 g/cm³ using a pressing machine in the step of fabricating the positive electrode.

### Examples 11-1 to 11-5 and Comparative Example 11-1

Batteries were obtained in the same manner as in Examples 2-1 to 2-5 except that the positive electrode active material layer was compression-molded until to have a volume density of 3.8 g/cm³ using a pressing machine in the step of fabricating the positive electrode.

### Examples 12-1 to 12-5 and Comparative Example 12-1

Batteries were obtained in the same manner as in Examples 2-1 to 2-5 except that the positive electrode active material layer was compression-molded until to have a volume density of 4.2 g/cm³ using a pressing machine in the step of fabricating the positive electrode.

The batteries obtained as described above were subjected to the evaluation on improvement rate of load characteristic as follows. First, the load characteristics of the batteries were determined in the same manner as in Example 1-1 described above. Next, the difference ΔR (=R−R₀) between the load characteristic R₀ of the batteries not containing a carboxylic acid ester (Comparative Examples 10-1, 11-1, and 12-1) and the load characteristic R of the batteries containing a carboxylic acid ester (Examples 10-1 to 10-5, 11-1 to 11-5, and 12-1 to 12-5) was calculated, and this ΔR was taken as the improvement rate of load characteristic.

Table 5 presents the configurations and evaluation results of the batteries in Examples 10-1 to 10-5, 11-1 to 11-5, and 12-1 to 12-5 and Comparative Examples 10-1, 11-1 and 12-1.

TABLE 5

| | | | | Solvent | | | |
|---|---|---|---|---|---|---|---|
| | | | | | | Number of | |
| | Melting | Content | Volume | | | carbon atoms | Load |
| | point of | of binder | density | Carbonic acid | Carboxylic acid | in carboxylic | characteristic |
| | binder | [% by mass] | [g/cm³] | ester [vol %] | ester [vol %] | acid ester | [%] |
| Example 10-1 | 166 | 1.4 | 3.7 | EC:PC = 11:9 | Ethyl acetate (80) | 4 | 9 |
| Example 10-2 | | | | EC:PC = 11:9 | Ethyl propionate (80) | 5 | 9 |
| Example 10-3 | | | | EC:PC = 11:9 | Propyl propionate (80) | 6 | 10 |
| Example 10-4 | | | | EC:PC = 11:9 | Butyl butyrate (80) | 8 | 8 |
| Example 10-5 | | | | EC:PC = 11:9 | Hexyl butyrate(80) | 10 | 6 |
| Comparative | | | | EC:PC:DMC:DEC:EMC = | — | — | 0 |
| Example 10-1 | | | | 11:9:47:4:29 | | | |
| Example 11-1 | 166 | 1.4 | 3.8 | EC:PC = 11:9 | Ethyl acetate (80) | 4 | 23 |
| Example 11-2 | | | | EC:PC = 11:9 | Ethyl propionate (80) | 5 | 22 |
| Example 11-3 | | | | EC:PC = 11:9 | Propyl propionate (80) | 6 | 24 |
| Example 11-4 | | | | EC:PC = 11:9 | Butyl butyrate (80) | 8 | 19 |
| Example 11-5 | | | | EC:PC = 11:9 | Hexyl butyrate(80) | 10 | 20 |
| Comparative | | | | EC:PC:DMC:DEC:EMC = | — | — | 0 |
| Example 11-1 | | | | 11:9:47:4:29 | | | |
| Example 12-1 | 166 | 1.4 | 4.2 | EC:PC = 11:9 | Ethyl acetate (80) | 4 | 34 |
| Example 12-2 | | | | EC:PC = 11:9 | Ethyl propionate (80) | 5 | 33 |
| Example 12-3 | | | | EC:PC = 11:9 | Propyl propionate (80) | 6 | 34 |
| Example 12-4 | | | | EC:PC = 11:9 | Butyl butyrate (80) | 8 | 27 |
| Example 12-5 | | | | EC:PC = 11:9 | Hexyl butyrate(80) | 10 | 29 |
| Comparative | | | | EC:PC:DMC:DEC:EMC = | — | — | 0 |
| Example 12-1 | | | | 11:9:47:4:29 | | | |

From the evaluation results presented in Table 5, it can be seen that the effect of improving the load characteristics is remarkable when the volume density of the positive electrode active material layer is in a range of 3.8 g/cm³ or more. exertion of this result is considered to be due to the following reasons. When the volume density is high, the flexibility of the positive electrode decreases since the compression molding is performed at a higher pressure. For this reason, when a flat-shaped wound electrode body is fabricated, the positive electrode is easily cracked at the folded portion of the positive electrode and cracking of the positive electrode proceeds by expansion and contraction at the time of charge and discharge. When an electrolytic solution containing a carboxylic acid ester is used in a battery including a flat-shaped wound electrode body, the impregnation property of the electrolytic solution into the positive electrode active material layer increases, the flexibility of the positive electrode active material layer is improved, and thus particularly favorable load characteristics can be attained. On the other hand, when an electrolytic solution not containing a carboxylic acid ester is used in a battery including a flat-shaped wound electrode body, the positive electrode active material layer collapses by swelling of the binder and the folded part of the positive electrode deteriorates as well as the impregnation property of the electrolytic solution into the positive electrode active material layer is poor, and thus the effect in a battery in which an electrolytic solution containing a carboxylic acid ester is used is not exerted.

The embodiments and Examples of the present technology have been specifically described above, but the present technology is not limited to the above-described embodiments and Examples, and various modifications can be made based on the technical idea of the present technology.

For example, the configurations, methods, steps, shapes, materials, numerical values and the like mentioned in the above-described embodiments and Examples are merely examples, and configurations, methods, steps, shapes, materials, numerical values and the like different from these may be used, if necessary. The chemical formulas of compounds and the like are representative ones, and the valences and the like are not limited to the described ones as long as the names are common names of the same compounds.

The configurations, methods, steps, shapes, materials, numerical values and the like of the above-described embodiments and Examples can be combined with each other without departing from the gist of the present technology.

In the above-described embodiments and Examples, examples in which the present invention is applied to cylindrical and laminate type secondary batteries have been described, but the shape of the battery is not particularly limited. For example, the present invention is also applicable to secondary batteries of a square type, a coin type and the like, and the present invention is also applicable to flexible batteries mounted on wearable terminals such as smart watches, head-mounted displays, and iGlass (registered trademark), and the like.

In the above-described embodiments and Examples, examples in which the present invention is applied to wound and laminate type secondary batteries have been described, but the structure of the battery is not limited to these, and the present invention is also applicable to, for example, a battery in which a positive electrode and a negative electrode are folded with a separator sandwiched therebetween.

The positive electrode active material layers 21B and 33B may further contain a binder other than the fluorine-based binder, if necessary. For example, the positive electrode active material layers 21B and 33B may contain at least one selected from resin materials such as polyacrylonitrile (PAN), styrene-butadiene rubber (SBR), and carboxymethyl cellulose (CMC), copolymers containing these resin materials as main components or the like in addition to the fluorine-based binder.

The positive electrode active material layers 21B and 33B may further contain a fluorine-based binder other than polyvinylidene fluoride, if necessary. For example, the positive electrode active material layers 21B and 33B may contain at least one of polytetrafluoroethylene (PTFE) or a VdF-based copolymer containing VdF as one of monomers in addition to polyvinylidene fluoride.

As the VdF-based copolymer, for example, it is possible to use a copolymer of vinylidene fluoride (VdF) and at least one selected from the group consisting of hexafluoropropylene (HFP), chlorotrifluoroethylene (CTFE), tetrafluoroethylene (TFE) and the like. More specifically, it is possible to use at least one selected from the group consisting of PVdF-HFP copolymer, PVdF-CTFE copolymer, PVdF-TFE copolymer, PVdF-HFP-CTFE copolymer, PVdF-HFP-TFE copolymer, PVdF-CTFE-TFE copolymer, PVdF-HFP-CTFE-TFE copolymer and the like. As the VdF-based copolymer, one obtained by modifying a part of its end and the like with a carboxylic acid such as maleic acid may be used.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A battery comprising a positive electrode, a negative electrode, and an electrolytic solution, wherein
the positive electrode includes a positive electrode active material layer including a fluorine-based binder having a melting point of 166° C. or less,
a content of the fluorine-based binder in the positive electrode active material layer is from 0.7% by mass to 2.8% by mass, and
the electrolytic solution includes a carboxylic acid ester, and the carboxylic acid ester has 4 or more and 10 or less carbon atoms.

2. The battery according to claim 1, wherein a volume density of the positive electrode active material layer is 3.8 g/cm³ or more.

3. The battery according to claim 1, wherein a content of the carboxylic acid ester in the electrolytic solution is from 40% by volume to 80% by volume.

4. The battery according to claim 1, wherein the electrolytic solution includes a carbonic acid ester.

5. The battery according to claim 4, wherein the carbonic acid ester includes ethylene carbonate.

6. The battery according to claim 4, wherein the carbonic acid ester includes ethylene carbonate and propylene carbonate.

7. The battery according to claim 1, wherein the fluorine-based binder includes vinylidene fluoride.

8. A battery pack comprising:
the battery according to claim 1; and
a controller configured to control the battery.

9. An electronic device comprising the battery according to claim 1, wherein
the electronic device is configured to receive power supply from the battery.

10. An electrically driven vehicle comprising:
the battery according to claim 1; and
a converter configured to receive power supply from the battery and convert the power into driving force for the electrically driven vehicle.

11. The electrically driven vehicle according to claim 10, further comprising a controller configured to perform information processing about vehicle control based on information about the battery.

12. A power storage system comprising the battery according to claim 1.
